(19) United States
(12) Patent Application Publication
(10) Pub. No.: US 2023/0410417 A1
(43) Pub. Date: Dec. 21, 2023

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: SHOHEI IWAMOTO, Kanagawa (JP)

(21) Appl. No.: 18/327,802

(22) Filed: Jun. 1, 2023

(30) Foreign Application Priority Data
Jun. 15, 2022 (JP) 2022-096458

(51) Int. Cl. G06T 15/20; G06T 7/70; G06T 17/00

(52) U.S. Cl. CPC G06T 15/205; G06T 7/70; G06T 17/00; G06T 2207/10012; G06T 2207/20092; G06T 2200/24; G06T 2207/30196

(57) ABSTRACT

An information processing apparatus acquires event information, and determines a position of a virtual viewpoint and a line-of-sight direction from the virtual viewpoint based on the event information before a three-dimensional model of a subject is generated. With the above configuration, a careless virtual viewpoint operation can be prevented when an event occurs.

### BACKGROUND OF THE DISCLOSURE

### Field of the Disclosure

The present disclosure relates to a technique for generating a virtual viewpoint image using a three-dimensional model.

### Description of the Related Art

Techniques for generating a virtual viewpoint image from a specified virtual viewpoint by using a plurality of images captured by a plurality of imaging apparatuses are attracting attention.

Japanese Patent Application Laid-Open No. 2020-144748 discusses a technique for predicting the motion of a three-dimensional model and determining the position of a virtual viewpoint.

There is a demand for generating a three-dimensional model immediately after capturing images, generating a virtual viewpoint image using the generated three-dimensional model, and distributing the virtual viewpoint image almost in real time. However, because processing for generating the three-dimensional model based on the captured images takes time, a time lag occurs between the time when the images are captured by actual cameras and the time when the virtual viewpoint image is generated. Thus, in a case where a user (an operator) performs a virtual viewpoint operation with reference to the virtual viewpoint image, the user also needs to consider a time lag to the time when the operation is reflected in the virtual viewpoint image. This makes it hard for the user to perform a virtual viewpoint operation suitable for an event.

### SUMMARY OF THE DISCLOSURE

The present disclosure is directed to preventing a careless virtual viewpoint operation at the time of occurrence of an event.

According to an aspect of the present disclosure, an information processing apparatus includes one or more memories storing instructions, and one or more processors executing the instructions to acquire event information, and determine a position of a virtual viewpoint and a line-of-sight direction from the virtual viewpoint based on the event information before a three-dimensional model of a subject is generated.

Further features of the present disclosure will become apparent from the following description of exemplary embodiments with reference to the attached drawings.

### BRIEF DESCRIPTION OF THE DRAWINGS

FIG. 1 is a block diagram illustrating an example of an apparatus configuration of an information processing system according to one or more aspects of the present disclosure.

FIG. 2 is a block diagram illustrating a hardware configuration of an information processing apparatus according to one or more aspects of the present disclosure.

FIG. 3 is a table illustrating event information managed by an event information management unit according to one or more aspects of the present disclosure.

FIG. 4 is a table illustrating virtual camera information generated by a virtual camera path generation unit according to one or more aspects of the present disclosure.

FIG. 5 is a flowchart illustrating virtual camera path generation based on the event information according to one or more aspects of the present disclosure.

FIG. 6 is a flowchart illustrating virtual camera path transmission according to one or more aspects of the present disclosure.

FIG. 7 is a block diagram illustrating a system configuration according to one or more aspects of the present disclosure.

FIG. 8 is a flowchart illustrating virtual camera path generation based on event information according to one or more aspects of the present disclosure.

FIG. 9 is a flowchart illustrating virtual camera path transmission according to one or more aspects of the present disclosure.

### DESCRIPTION OF THE EMBODIMENTS

Exemplary embodiments of the present disclosure will be described below with reference to the accompanying drawings. The present disclosure is not limited to the following exemplary embodiments. In the drawings, identical members or elements are assigned the same reference numerals, and duplicated descriptions thereof will be omitted or simplified.

An information processing system according to a first exemplary embodiment generates a virtual viewpoint image viewed from a specified virtual viewpoint based on images captured from different directions by a plurality of imaging apparatuses (cameras), statuses of the imaging apparatuses, and the virtual viewpoint. A virtual viewpoint image according to the present exemplary embodiment is also referred to as a free viewpoint video image, but is not limited to an image corresponding to a viewpoint freely (optionally) specified by a user. Examples of the virtual viewpoint image include an image corresponding to a viewpoint selected from among a plurality of candidates by the user. The present exemplary embodiment will be described below focusing on a case where a virtual viewpoint is specified through a user operation. Alternatively, a virtual viewpoint can be automatically specified based on, for example, an image analysis result. The present exemplary embodiment will also be described below focusing on a case where a virtual viewpoint image is a moving image. Alternatively, a virtual viewpoint image can be a still image.

Viewpoint information used to generate a virtual viewpoint image indicates the position and orientation (line-of-sight direction) of a virtual viewpoint. More specifically, the viewpoint information is a parameter set including a parameter representing the three-dimensional position of a virtual viewpoint, and a parameter representing the orientation of the virtual viewpoint in pan, tilt, and roll directions. The contents of the viewpoint information are not limited thereto. For example, the parameter set as the viewpoint information can include a parameter representing the size of the visual field (the angle of view) of the virtual viewpoint. The viewpoint information can also include a plurality of parameter sets. For example, the viewpoint information can include a plurality of parameter sets respectively corresponding to a plurality of frames included in the moving image as the virtual viewpoint image, and can be information indicating the position and orientation of the virtual viewpoint at each of a plurality of continuous points of time.

The image processing system includes a plurality of imaging apparatuses that captures images of an imaging region from a plurality of directions. The imaging region is, for example, a sports stadium where sports such as soccer and karate are performed or a stage where concerts and dramas are performed. The plurality of imaging apparatuses is installed at different positions surrounding such an imaging region, and captures images in synchronization with each other. The plurality of imaging apparatuses may not necessarily be installed over the entire circumference of the imaging region and can be installed at a part of the circumference of the imaging region due to reasons such as limitations on installation locations. Alternatively, the plurality of imaging apparatuses having different functions, such as telephotographic cameras and wide-angle cameras, can be installed.

Each of the plurality of imaging apparatuses according to the present exemplary embodiment has an independent housing and is a camera capable of capturing images with a single viewpoint. However, the present disclosure is not limited thereto. Two or more imaging apparatuses can be included in the same housing. For example, a single camera including a plurality of lens groups and a plurality of sensors and capable of capturing images from a plurality of viewpoints can be installed as the plurality of imaging apparatuses.

A virtual viewpoint image is generated, for example, by the following method. First, the plurality of imaging apparatuses captures images from different directions to acquire a plurality of captured images (a plurality of viewpoint images). Then, a foreground image is obtained by extracting a foreground region corresponding to predetermined objects such as a person and a ball from the plurality of viewpoint images, and a background image is obtained by extracting a background region other than the foreground region from the plurality of viewpoint images. A foreground model representing the three-dimensional shape of a predetermined object and texture data for coloring the foreground model are generated based on the foreground image. Texture data for coloring a background model representing the three-dimensional shape of a background such as a sports stadium is generated based on the background image. The foreground model and the background model are subjected to texture data mapping and rendering based on the virtual viewpoint indicated by the viewpoint information to generate a virtual viewpoint image. The method for generating a virtual viewpoint image is not limited thereto. Various examples of the method include generating a virtual viewpoint image by projection conversion of captured images without three-dimensional models.

A virtual camera, which is different from the plurality of imaging apparatuses actually installed around the imaging region, is a concept for conveniently explaining a virtual viewpoint related to the generation of a virtual viewpoint image. More specifically, a virtual viewpoint image can be considered as an image captured from a virtual viewpoint set in a virtual space related to the imaging region. The position and orientation of the viewpoint in such virtual image capturing can be represented as the position and orientation of the virtual camera. In other words, assuming that a camera exists at the position of a virtual viewpoint set in a space, a virtual viewpoint image refers to an image that simulates a captured image acquired by the camera. In the present exemplary embodiment, the transition of a virtual viewpoint over time is referred to as a virtual camera path. However, it is not essential to use the concept of the virtual camera in order to implement the configuration according to the present exemplary embodiment. It is sufficient to set at least information representing specific position and orientation in a space and generate a virtual viewpoint image based on the set information.

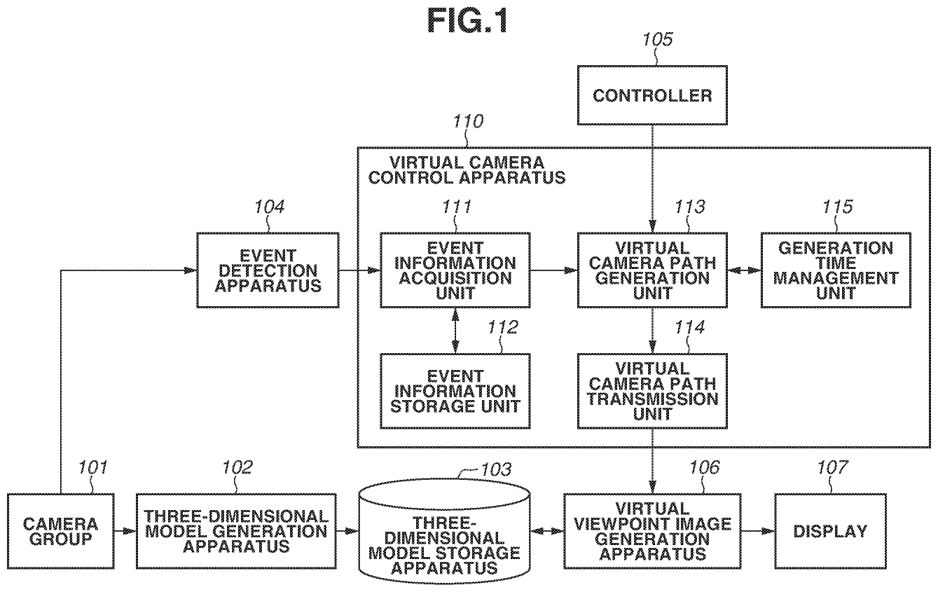

FIG. 1 illustrates a system configuration according to the present exemplary embodiment.

A camera group 101 includes a plurality of cameras arranged at different positions in, for example, a stadium where basketball is performed, and the plurality of cameras captures images from a plurality of viewpoints in synchronization with each other. Data of the plurality of viewpoint images acquired in the synchronous image capturing is transmitted to a three-dimensional model generation apparatus 102 and an event detection apparatus 104.

The three-dimensional model generation apparatus 102 receives the plurality of viewpoint images from the camera group 101 and generates a three-dimensional model. For example, Visual Hull (Shape from Silhouette) is used to generate a three-dimensional model. As a result of this processing, a three-dimensional (3D) point group (a set of points having three-dimensional coordinates) representing the three-dimensional shape of a subject is obtained. The method for deriving the three-dimensional shape of a subject based on the captured images is not limited thereto.

A three-dimensional model storage apparatus 103 stores the three-dimensional model generated by the three-dimensional model generation apparatus 102, in association with time information. Based on time information received from a virtual viewpoint image generation apparatus 106, the three-dimensional model storage apparatus 103 also transmits the three-dimensional model associated with the time information to the virtual viewpoint image generation apparatus 106.

The event detection apparatus 104 detects an event corresponding to a time and a subject based on the plurality of viewpoint images received from the camera group 101. In the present exemplary embodiment, an event is caused by an action of a subject or a phenomenon on a subject. For example, the event detection apparatus 104 detects an event caused by a subject, such as traveling in a basketball game. While in the present exemplary embodiment, the event detection apparatus 104 is described to detect an event based on a result of image processing on the images captured by the camera group 101, the trigger for detecting an event is not limited to the input from the camera group 101. For example, the event detection apparatus 104 can detect an event based on a signal obtained from a sensor such as a goal sensor or a starter pistol sensor in track competitions, or a sword tip sensor in fencing. Alternatively, the event detection apparatus 104 can detect an event based on a result of analyzing sound information acquired through a microphone. The event detection apparatus 104 can also detect an event by separately preparing a learning model that inputs the captured images and outputs an event. In the present exemplary embodiment, the event detection apparatus 104 acquires position information about a subject that has caused the detection of an event, by subjecting the captured images to stereo matching, and includes the position information in event information. The method for acquiring the position information about the subject is not limited thereto. The position information about the subject can be acquired by extracting feature points from the captured images. The event detection apparatus 104 transmits the event information about the detected event to an event information acquisition unit 111.

A virtual camera control apparatus 110 includes the event information acquisition unit 111, an event information storage unit 112, a virtual camera path generation unit 113, a virtual camera path transmission unit 114, and a generation time management unit 115.

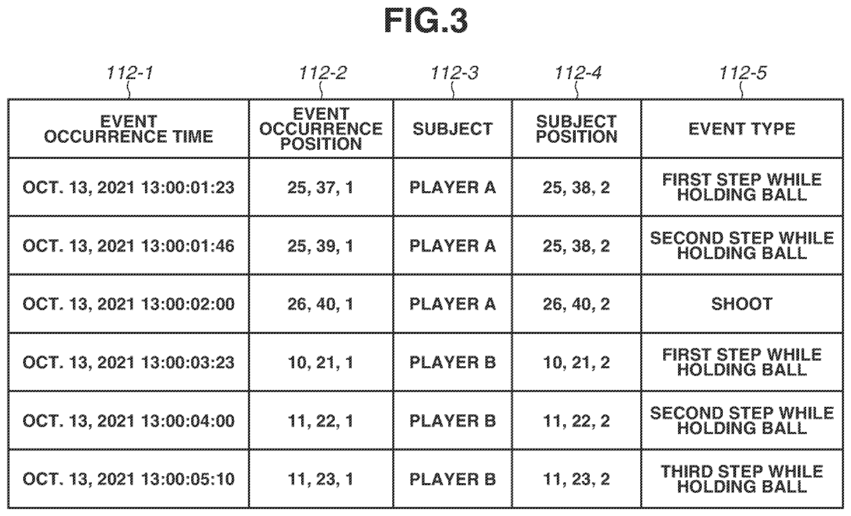

FIG. 3 is a table illustrating an example of data stored by the event information storage unit 112. The event information storage unit 112 stores an event and a subject in association with each other. In the present exemplary embodiment, a description will be given taking basketball as an example. Events to be captured are not limited to events of basketball but can include events of baseball and other ball games, track and field competitions, and idol concerts.

An event occurrence time 112-1 represents the time when each event has occurred. In the present exemplary embodiment, the storage format is “month, day, year, hour: minute: second: frame” with a frame rate of 60 frames per second (fps). This means that each frame takes a value from 0 to 59.

An event occurrence position 112-2 represents the position where the event has occurred. In the present exemplary embodiment, the storage format is “x-coordinate, y-coordinate, z-coordinate” expressed in meters (m).

A subject 112-3 represents the subject that has caused the event.

A subject position 112-4 represents the position information about the subject that has caused the event. In the present exemplary embodiment, the center-of-gravity position of the subject is the position information about the subject. The position information about the subject is not limited thereto but can indicate the position of a part of the subject, such as the head or right hand of the subject.

An event type 112-5 represents what type of event has occurred. In the present exemplary embodiment, the event type 112-5 describes event types in a basketball game. For example, the event type “third step while holding ball” represents a traveling foul. In the present exemplary embodiment, the event types are assumed to be defined in advance.

The event information acquisition unit 111 acquires the event information about the event detected by the event detection apparatus 104, and registers the acquired event information in the event information storage unit 112. As described above with reference to FIG. 3, the event information includes the event occurrence time 112-1, the event occurrence position 112-2, the subject 112-3, the subject position 112-4, and the event type 112-5. The event information acquisition unit 111 determines whether a virtual camera path can be generated, based on the event information. If a virtual camera path can be generated based on the event information, the event information acquisition unit 111 acquires all pieces of event information to be used to generate a virtual camera path from the event information storage unit 112, and transmits these pieces of event information to the virtual camera path generation unit 113. In the present exemplary embodiment, for example, upon acquisition of event information about an event caused by a player B, “third step while holding ball”, the event information acquisition unit 111 registers the event information in the event information storage unit 112. Thereafter, the event information acquisition unit 111 acquires event information corresponding to the immediately preceding events caused by the player B, “first step while holding ball” and “second step while holding ball”, from the event information storage unit 112, and transmits these pieces of event information to the virtual camera path generation unit 113.

The virtual camera path generation unit 113 generates a virtual camera path based on virtual camera operation information acquired from a controller 105 and a virtual viewpoint image reproduction time acquired from the generation time management unit 115. Alternatively, the virtual camera path generation unit 113 can generate a virtual camera path based on the event information acquired from the event information acquisition unit 111. The virtual camera path generation unit 113 transmits the generated virtual camera path to the virtual camera path transmission unit 114. In real-time distribution, a time lag occurs between the time when the cameras capture the images and the time when a virtual viewpoint image is displayed. The time lag corresponds to the processing time from the time when the captured images are acquired to the time when a three-dimensional model is generated and then a virtual viewpoint image is generated. Thus, a user who specifies a virtual viewpoint using the controller 105 is to perform an operation considering the time lag, which makes it hard for the user to perform a virtual viewpoint operation suitable for a sudden event. In the present exemplary embodiment, the operation information from the controller 105 is ignored if a virtual camera path generated based on event information exists before a three-dimensional model is generated based on captured images. More specifically, if a sudden event occurs, a virtual camera path is generated before a three-dimensional model is generated, whereby a virtual viewpoint suitable for the event can be generated. In the present exemplary embodiment, however, the operation information from the controller 105 may not necessarily be ignored. For example, a virtual camera path generated based on event information can be corrected based on the operation information from the controller 105. Alternatively, a switch for determining which of the pieces of information is to be given priority when generating a virtual camera path can be provided. This switch can be implemented by hardware or implemented on a software user interface (UI). Further alternatively, a virtual camera path can be generated based on event information and the position of the virtual camera before acquisition of the event information.

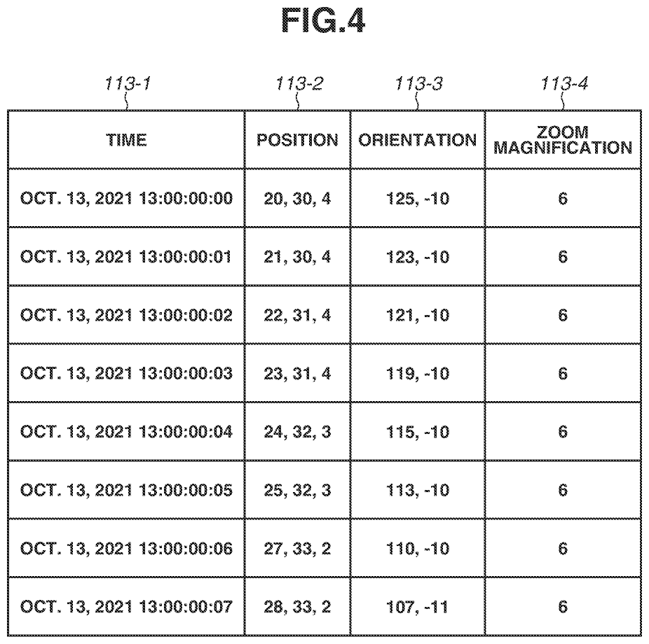

FIG. 4 is a table illustrating an example of virtual camera information generated by the virtual camera path generation unit 113.

A time 113-1 represents the time when the virtual camera is generated. In the present exemplary embodiment, the storage format is “month, day, year, hour: minute: second: frame” with a frame rate of 60 fps. This means that each frame takes a value from 0 to 59.

A position 113-2 represents the position of the virtual camera. In the present exemplary embodiment, the storage format is “x-coordinate, y-coordinate, z-coordinate” expressed in meters (m).

An orientation 113-3 represents the orientation of the virtual camera. In the present exemplary embodiment, the storage format is “pan angle, tilt angle” expressed in degrees. The pan angle takes a value from 0 to 360 degrees with respect to a certain direction defined as 0 degrees. The tilt angle takes a value from −180 to 180 degrees with respect to the horizontal direction defied as 0 degrees. The orientation from the horizontal direction upward is represented by a positive value, and the orientation from the horizontal direction downward is represented by a negative value.

A zoom magnification 113-4 represents the focal length of the virtual camera expressed in millimeters (mm). More specifically, a smaller value indicates a wider angle, and a larger value indicates a more telephoto side.

As described above, the virtual camera path is defined so as to associate the values of the time 113-1, the position 113-2, the orientation 113-3, and the zoom magnification 113-4 with each other.

The generation time management unit 115 manages the time when the virtual viewpoint image generation apparatus 106 can generate a virtual viewpoint image. In the present exemplary embodiment, the format of the time when a virtual viewpoint image can be generated is “month, day, year, hour: minute: second: frame” with a frame rate of 60 fps. This means that each frame takes a value from 0 to 59 and the value is incremented by one at intervals of 1/60 seconds. In the present exemplary embodiment, the time when a virtual viewpoint image can be generated is delayed from the current time. The delay time duration is longer than the time duration taken for the three-dimensional model generation apparatus 102 to generate a three-dimensional model. While in the present exemplary embodiment, the user can optionally set how much the time when a virtual viewpoint image can be generated is to be delayed from the current time, the present exemplary embodiment is not limited thereto. For example, the generation time management unit 115 can obtain the maximum time duration taken for the three-dimensional model generation apparatus 102 to generate a three-dimensional model, and automatically determine the time when a virtual viewpoint image can be generated, based on the maximum time duration.

The virtual camera path transmission unit 114 transmits, to the virtual viewpoint image generation apparatus 106, the virtual camera path transmitted from the virtual camera path generation unit 113. In the present exemplary embodiment, the virtual camera path transmission unit 114 transmits the virtual camera path at 60 fps intervals.

The virtual viewpoint image generation apparatus 106 generates a virtual viewpoint image based on the virtual camera path acquired from the virtual camera path transmission unit 114. The virtual viewpoint image generation apparatus 106 transmits the time 113-1 of the acquired virtual camera path to the three-dimensional model storage apparatus 103 to acquire the three-dimensional model corresponding to the time 113-1. For the acquired three-dimensional model, the virtual viewpoint image generation apparatus 106 generates a video image captured by the virtual camera virtually generated based on the values of the position 113-2, the orientation 113-3, and the zoom magnification 113-4 of the acquired virtual camera path, as a virtual viewpoint image. The virtual viewpoint image generation apparatus 106 transmits the generated virtual viewpoint image to a display 107.

The display 107 outputs the virtual viewpoint image acquired from the virtual viewpoint image generation apparatus 106. In the present exemplary embodiment, the operator is assumed to operate the virtual camera by operating the controller 105 while watching the virtual viewpoint image output to the display 107.

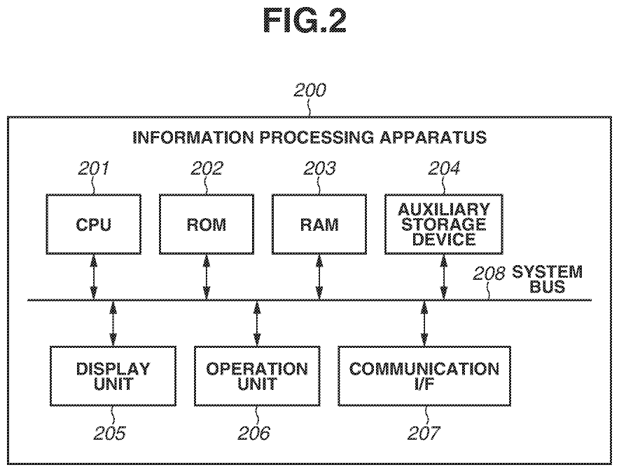

FIG. 2 illustrates hardware resources of each of the apparatuses of the system illustrated in FIG. 1. Each of the three-dimensional model generation apparatus 102, the three-dimensional model storage apparatus 103, the event detection apparatus 104, the virtual camera control apparatus 110, and the virtual viewpoint image generation apparatus 106 can be implemented by an information processing apparatus 200 illustrated in FIG. 2.

The information processing apparatus 200 includes a central processing unit (CPU) 201, a read only memory (ROM) 202, a random access memory (RAM) 203, an auxiliary storage device 204, a display unit 205, an operation unit 206, a communication I/F 207, and a system bus 208.

The CPU 201 controls the entire information processing apparatus 200 using computer programs and data stored in the ROM 202 or the RAM 203 to implement the corresponding function of the system illustrated in FIG. 1. The information processing apparatus 200 can include one or a plurality of dedicated hardware components different from the CPU 201, and the dedicated hardware components can perform at least a part of the processing performed by the CPU 201. Examples of such dedicated hardware components include an application specific integrated circuit (ASIC), a field programmable gate array (FPGA), and a digital signal processor (DSP).

The ROM 202 stores programs not to be changed. The RAM 203 temporarily stores programs and data supplied from the auxiliary storage device 204, and data supplied from the outside via the communication I/F 207. The auxiliary storage device 204, such as a hard disk drive, stores image data, sound data, and other types of data.

The display unit 205 including, for example, a liquid crystal display or a light emitting diode (LED) displays a graphical user interface (GUI) used by the user to issue instructions to the information processing apparatus 200.

The operation unit 206 including, for example, a keyboard, a mouse, a joystick, or a touch panel receives operations from the user and inputs various instructions to the CPU 201. The CPU 201 operates as a display control unit for controlling the display unit 205 and an operation control unit for controlling the operation unit 206.

The communication I/F 207 is used to communicate with apparatuses outside the information processing apparatus 200, such as the camera group 101 and a microphone group. If the information processing apparatus 200 has a function of wirelessly communicating with an external apparatus, the communication I/F 207 includes an antenna.

The system bus 208 connects the components of the information processing apparatus 200 to transfer information therebetween.

In the present exemplary embodiment, the display unit 205 and the operation unit 206 are included inside the information processing apparatus 200. Alternatively, at least one of the display unit 205 and the operation unit 206 can exist as a separate apparatus outside the information processing apparatus 200.

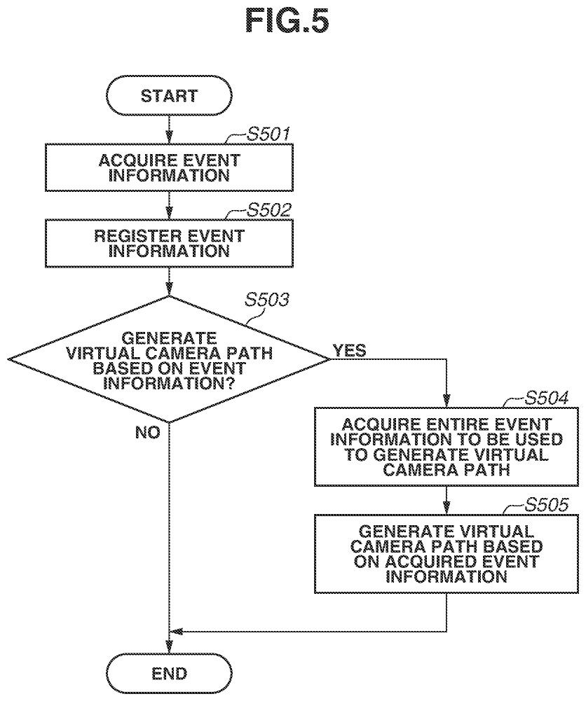

FIG. 5 is a flowchart illustrating processing performed by the virtual camera control apparatus 110 to generate a virtual camera path based on event information.

In step S501, the event information acquisition unit 111 acquires event information from the event detection apparatus 104. The event information is a data group including the event occurrence time 112-1, the event occurrence position 112-2, the subject 112-3, the subject position 112-4, and the event type 112-5. The event occurrence time 112-1 included in the event information acquired in this step is assumed to be earlier than the current time and later than the time when a virtual viewpoint image can be generated. In other words, the event occurrence time 112-1 is the time after the time when a virtual viewpoint image can be generated and before the current time, and is the time when a virtual viewpoint is not specified by the user.

In step S502, the event information acquisition unit 111 registers the event information acquired in step S501 in the event information storage unit 112. In the registration, for example, the event information acquisition unit 111 adds data to the table representing the event information in FIG. 3.

In step S503, the event information acquisition unit 111 determines whether to generate a virtual camera path based on the event information acquired in step S501. While in the present exemplary embodiment, the determination method is not specifically defined, for example, a rule that a virtual camera path is determined to be generated if the event type 112-5 of the event information is “third step while holding ball” is set in advance, and the event information acquisition unit 111 can make the determination according to the rule.

If the event information acquisition unit 111 determines not to generate a virtual camera path based on the acquired event information (NO in step S503), the processing ends. If the event information acquisition unit 111 determines to generate a virtual camera path based on the acquired event information (YES in step S503), the processing proceeds to step S504. In step S504, the event information acquisition unit 111 acquires the entire event information to be used to generate a virtual camera path from the event information storage unit 112, based on the event information acquired in step S501. For example, if the event type 112-5 of the event information acquired in step S501 is “third step while holding ball”, the event information acquisition unit 111 acquires the event information corresponding to “first step while holding ball” and “second step while holding ball” pre-registered for the same subject in the event information storage unit 112.

In step S505, the virtual camera path generation unit 113 generates a virtual camera path based on one or more pieces of event information acquired in step S504. At this time, the virtual camera path generation unit 113 generates a virtual camera path in the format represented by the table illustrated in FIG. 4. For example, if the event information about the player B corresponding to “first step while holding ball”, “second step while holding ball”, and “third step while holding ball” is acquired like the example illustrated in step S504, the virtual camera path generation unit 113 determines the position and orientation of the virtual camera so that a virtual viewpoint image in which the feet of the subject (the player B) are easy to see can be generated. In other words, the virtual camera path generation unit 113 determines the position and orientation of the virtual camera so that the event occurrence position 112-2 is included in the virtual viewpoint image. The virtual camera path generation unit 113 can determine the position and orientation of the virtual camera so that the event occurrence position 112-2 is at the center of the virtual viewpoint image, based on the position information of the event occurrence position 112-2. Alternatively, the virtual camera path generation unit 113 can determine the position and orientation of the virtual camera so that the subject that has caused the event is at the center of the virtual viewpoint image, based on the position information about the subject. Further alternatively, the virtual camera path generation unit 113 can determine the orientation of the virtual camera so that the event occurrence position 112-2 is at the center of the virtual viewpoint image, assuming that the virtual camera is positioned on the straight line connecting the position of an actual camera having captured an image used in the event detection and the event occurrence position 112-2. The virtual camera path generation unit 113 determines the times of the virtual camera path so as to include at least the period from the time when the event “first step while holding ball” has occurred to the time when the event “third step while holding ball” has occurred. A specific example thereof is as follows. The virtual camera path generation unit 113 captures the position of the first step while holding the ball at the center of the angle of view, and sets a position 3 m away from the player B on the straight line connecting the position of the player B and the position of an actual camera used in the event detection, as a camera position 1. The distance from the player B can be prestored as a fixed value or dynamically changed depending on the condition. In the present exemplary embodiment, the distance is fixed to 3 m. While in the present exemplary embodiment, the focal length of the virtual camera is fixed to 6 mm, the focal length can be prestored as a fixed value or dynamically changed depending on the condition. Likewise, the virtual camera path generation unit 113 captures the position of the second step while holding the ball at the center of the angle of view, and sets a position 3 m away from the player B as a camera position 2. The virtual camera path generation unit 113 captures the position of the third step while holding the ball at the center of the angle of view, and sets a position 3 m away from the player B as a camera position 3. While the pan and tilt angles are set to the same fixed values for all of the camera positions 1 to 3, the values can be dynamically changed depending on the condition. The times of the camera positions 1 to 3 are matched with the occurrence times of the first step while holding the ball to the third step while holding the ball, respectively. The virtual camera path generation unit 113 then performs interpolation processing for connecting the camera positions 1 to 3 to generate interpolation information (a line) that connects the camera positions 1 to 3, and generates a virtual camera path so that the virtual camera moves on the generated line during the period from the occurrence time of the first step while holding the ball to the occurrence time of the third step while holding the ball. While in the interpolation processing, the virtual camera path generation unit 113 performs spline interpolation to generate a curved line for the smooth movement of the virtual camera, the interpolation processing is not limited thereto. The virtual camera path generation unit 113 can perform linear interpolation. The method for generating the line connecting the camera positions 1 to 3 is not limited thereto. In the above-described manner, the virtual camera path generation unit 113 automatically generates the virtual camera path corresponding to the period from the occurrence time of the first step while holding the ball to the occurrence time of the third step while holding the ball. In the present exemplary embodiment, the virtual camera path generated in step S505 is stored in the virtual camera control apparatus 110.

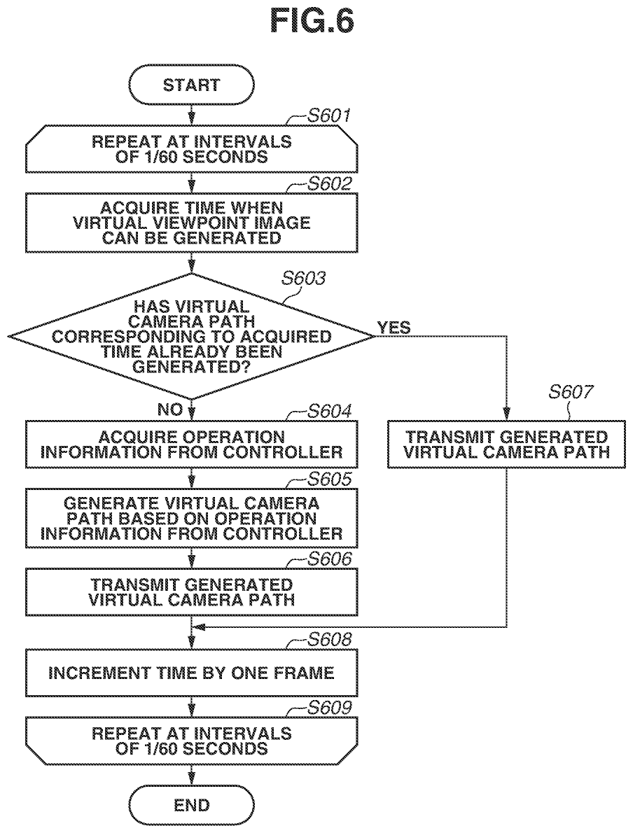

FIG. 6 is a flowchart illustrating processing performed by the virtual camera control apparatus 110 to transmit a virtual camera path to the virtual viewpoint image generation apparatus 106 at intervals of 1/60 seconds. This flowchart operates in parallel with the flowchart in FIG. 5.

In the present exemplary embodiment, the virtual camera control apparatus 110 repeats steps S601 to S609 at intervals of 1/60 seconds. This repetition interval is due to the generation of a virtual camera path at a frame rate of 60 fps. This means that, when generating a virtual camera path at a frame rate of 30 fps, the virtual camera control apparatus 110 repeats steps S601 to S609 at intervals of 1/30 seconds. The repetition interval can be optionally set by the user.

In step S602, the virtual camera path generation unit 113 acquires the time when a virtual viewpoint image can be generated that is managed by the generation time management unit 115.

In step S603, the virtual camera path generation unit 113 determines whether a virtual camera path based on event information has already been generated at the time acquired in step S602. More specifically, the virtual camera path generation unit 113 determines whether data of the virtual camera path corresponding to the time acquired in step S602 is generated in step S505 in FIG. 5. If a virtual camera path based on event information has already been generated at the acquired time (YES in step S603), the processing proceeds to step S607. If a virtual camera path based on event information has not been generated at the acquired time (NO in step S603), the processing proceeds to step S604.

In step S604, the virtual camera path generation unit 113 acquires the operation information from the controller 105. This means that the result of the determination in step S603 indicates that a virtual camera path based on event information does not exist at the time acquired in step S602 and thus a virtual camera path is to be generated based on the operation information from the controller 105.

In step S605, the virtual camera path generation unit 113 generates a virtual camera path based on the operation information acquired in step S604 and the time information acquired in step S602.

In step S606, the virtual camera path transmission unit 114 transmits the virtual camera path generated in step S605 to the virtual viewpoint image generation apparatus 106.

In step S607, the virtual camera path transmission unit 114 transmits the data corresponding to the time acquired in step S602 in the virtual camera path generated in step S505 to the virtual viewpoint image generation apparatus 106.

In step S608, the generation time management unit 115 increments the time when a virtual viewpoint image can be generated, for one frame.

As described above, in the present exemplary embodiment, the virtual camera control apparatus 110 transmits a virtual camera path based on the operation information from the controller 105. The virtual camera control apparatus 110 also transmits a virtual camera path generated based on event information to the virtual viewpoint image generation apparatus 106 upon acquisition of the event information. As described above in step S501, it is assumed that, upon acquisition of event information, the event occurrence time is earlier than the current time and later than the time when a virtual viewpoint image can be generated. This enables generating a virtual camera path before generation of a three-dimensional model, thereby preventing a careless virtual viewpoint operation at the time of occurrence of an event.

The present exemplary embodiment makes it possible to prevent a careless virtual viewpoint operation at the time of occurrence of an event.

In the first exemplary embodiment, the method has been described in which the system that acquires event information about an event that occurs later than the time when a virtual viewpoint image can be generated generates a virtual camera path based on the acquired event information. However, there may be a case where the event detection apparatus 104 is unable to constantly detect an event at the same time as the current time. In such a case, at the point in time of acquisition of the event information by the event information acquisition unit 111, the event occurrence time may be earlier than the time when a virtual viewpoint image can be generated. To address the issue, in a second exemplary embodiment, a configuration will be described in which the time when a virtual viewpoint image can be generated and the event occurrence time are compared with each other and, only if the event occurrence time is later than the time when a virtual viewpoint image can be generated, a virtual camera path based on event information is generated.

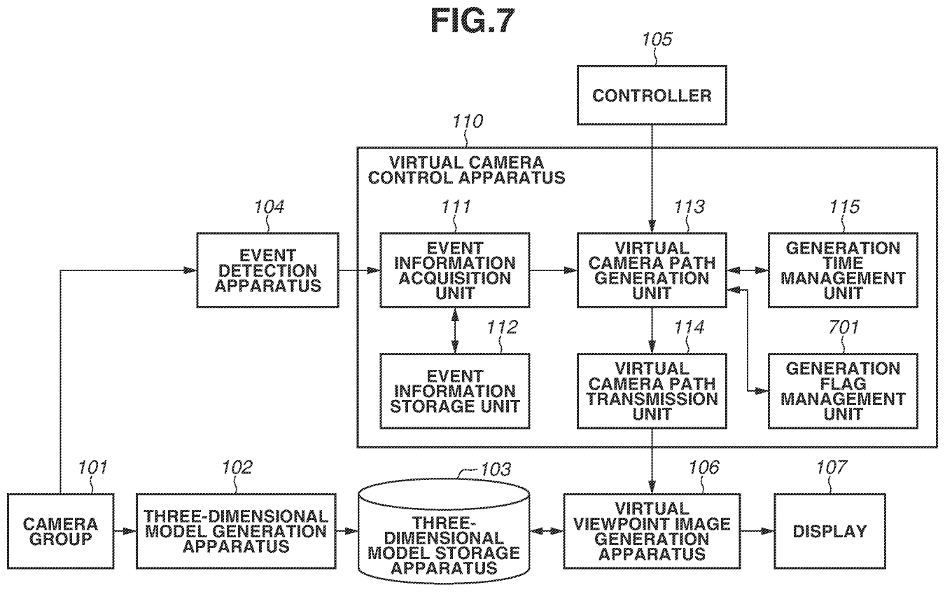

FIG. 7 is a system configuration according to the present exemplary embodiment. Components other than a generation flag management unit 701 are similar to those illustrated in FIG. 1, and redundant descriptions thereof will be omitted.

The generation flag management unit 701 manages a virtual camera path generation flag. When the virtual camera path generation unit 113 generates a virtual camera path based on event information, the flag is changed to TRUE. The virtual camera path generation flag is used to determine whether a virtual camera path has been generated based on event information. If the flag is TRUE, the virtual camera path generation unit 113 compares the time when a virtual viewpoint image can be generated and the time of the generated virtual camera path with each other. If the time of the generated virtual camera path is later than the time when a virtual viewpoint image can be generated, the virtual camera path generation unit 113 stores the generated virtual camera path. If the time of the generated virtual camera path is earlier than the time when a virtual viewpoint image can be generated, the virtual camera path generation unit 113 deletes the virtual camera path. After deleting the generated virtual camera path, the virtual camera path generation unit 113 generates a virtual camera path based on the operation information from the controller 105 as usual, and transmits the generated virtual camera path to the virtual viewpoint image generation apparatus 106.

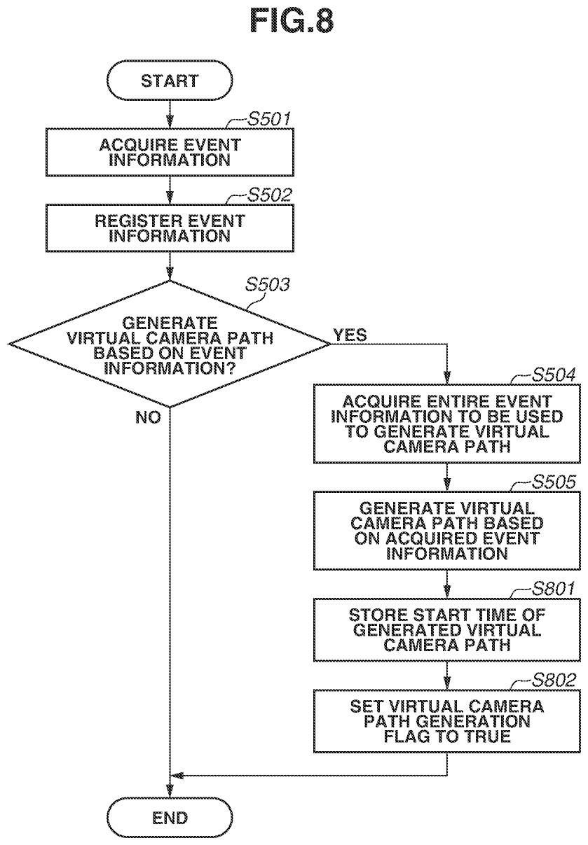

FIG. 8 is a flowchart illustrating processing performed by the virtual camera control apparatus 110 to generate a virtual camera path based on event information. Steps other than steps S801 and S802 are similar to the steps in FIG. 5, and redundant descriptions thereof will be omitted.

In step S801, the virtual camera control apparatus 110 stores the start time of the virtual camera path generated in step S505, i.e., the earliest time of the generated virtual camera path.

In step S802, the virtual camera control apparatus 110 changes the virtual camera path generation flag managed by the generation flag management unit 701 to TRUE.

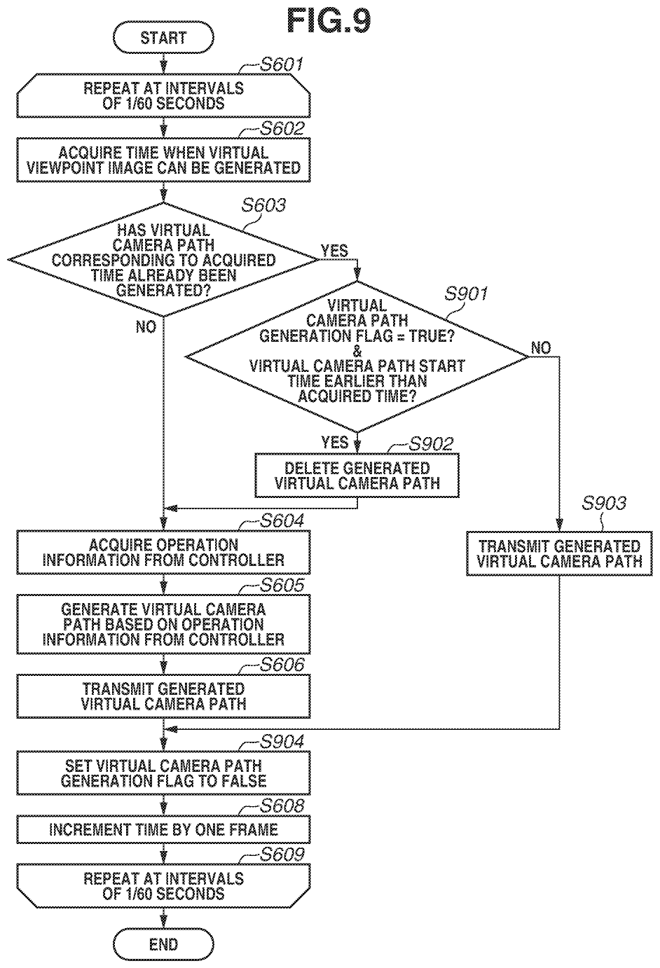

FIG. 9 is a flowchart illustrating processing performed by the virtual camera control apparatus 110 to transmit a virtual camera path to the virtual viewpoint image generation apparatus 106 at intervals of 1/60 seconds. This flowchart operates in parallel with the flowchart in FIG. 6.

In the present exemplary embodiment, the virtual camera control apparatus 110 repeats steps S601 to S609 at intervals of 1/60 seconds. This repetition interval is due to the generation of a virtual camera path at a frame rate of 60 fps. Steps other than steps S901 to S904 are similar to the steps in FIG. 6, and redundant descriptions thereof will be omitted.

In step S901, the virtual camera path generation unit 113 determines whether the virtual camera path generation flag managed by the generation flag management unit 701 is TRUE. If the flag is FALSE (NO in step S901), the processing proceeds to step S903. If the flag is TRUE, the virtual camera control apparatus 110 further compares the time when a virtual viewpoint image can be generated and the start time of the virtual camera path determined to have been generated in step S603. If the virtual camera path start time is earlier than the time when a virtual viewpoint image can be generated as a result of the comparison (YES in step S901), the processing proceeds to step S902. If the virtual camera path start time is later than the time when a virtual viewpoint image can be generated (NO in step S901), the processing proceeds to step S903.

In step S902, the virtual camera path generation unit 113 deletes the virtual camera path determined to have been generated in step S603 from the virtual camera path generation unit 113. In other words, if a virtual camera path is generated based on event information but the start time is earlier than the time when a virtual viewpoint image can be generated, the generated virtual camera path is to be discarded. After step S902, the processing proceeds to step S604. In step S604, the virtual camera control apparatus 110 performs the processing for generating a virtual camera path based on the operation information from the controller 105 as usual.

In step S903, the virtual camera path transmission unit 114 transmits the virtual camera path determined to have been generated in step S603 to the virtual viewpoint image generation apparatus 106.

In step S904, the generation flag management unit 701 changes the virtual camera path generation flag managed by the generation flag management unit 701 to FALSE.

As described above, according to the present exemplary embodiment, the virtual camera path generation unit 113 determines whether, in a case where a virtual camera path is generated based on event information, the start time is later than the time when a virtual viewpoint image can be generated, to determine whether to apply the generated virtual camera path.

A computer program for implementing part or whole of control according to the above-described exemplary embodiments, i.e., the functions according to the above-described exemplary embodiments can be supplied to an image processing system via a network or various types of storage media, and a computer (or a CPU or a micro processing unit (MPU)) of the image processing system can read and execute the program. In this case, the program and a storage medium storing the program are included in the exemplary embodiments of the present disclosure.

The exemplary embodiments of the present disclosure include the following configurations, method, and storage medium:
<Configuration 1>
An information processing apparatus determines a virtual viewpoint corresponding to a virtual viewpoint image that is generated using a three-dimensional model based on a plurality of images captured by a plurality of imaging apparatuses. The information processing apparatus includes an acquisition unit configured to acquire event information, and a determination unit configured to determine a position of the virtual viewpoint and a line-of-sight direction from the virtual viewpoint based on the event information before the three-dimensional model of a subject is generated.
<Configuration 2>
In the information processing apparatus according to the configuration 1, the event information is information indicating an action of the subject or an event caused by the subject. In a case where the event information indicates a specific action of the subject or the event caused by the subject, the determination unit determines the position of the virtual viewpoint and the line-of-sight direction from the virtual viewpoint.
<Configuration 3>
In the information processing apparatus according to the configuration 2, the event information is information including an event occurrence position indicating a position where the action of the subject is identified or a position where the event caused by the subject is identified. The determination unit determines the position of the virtual viewpoint and the line-of-sight direction from the virtual viewpoint so that the event occurrence position is included in the virtual viewpoint image.
<Configuration 4>
In the information processing apparatus according to the configuration 3, the determination unit determines the position of the virtual viewpoint and the line-of-sight direction from the virtual viewpoint so that the event occurrence position is at a center of the virtual viewpoint image.
<Configuration 5>
In the information processing apparatus according to the configuration 1, the acquisition unit acquires position information about the subject. Based on the position information about the subject, the determination unit determines the position of the virtual viewpoint and the line-of-sight direction from the virtual viewpoint so that the subject is included in the virtual viewpoint image.
<Configuration 6>
In the information processing apparatus according to the configuration 5, the determination unit determines the position of the virtual viewpoint and the line-of-sight direction from the virtual viewpoint so that the subject is at a center of the virtual viewpoint image.
<Configuration 7>
In the information processing apparatus according to configuration 5, the plurality of images is images of the subject captured from different directions. The acquisition unit acquires the position information about the subject by using a stereo matching method based on the plurality of images.
<Configuration 8>
In the information processing apparatus according to the configuration 2, the event information is information including an occurrence time of the action of the subject or the event caused by the subject.
<Configuration 9>
In the information processing apparatus according to the configuration 1, the acquisition unit acquires the event information based on the plurality of images.
<Configuration 10>
In the information processing apparatus according to the configuration 9, the acquisition unit acquires the event information by using a learning model that inputs the plurality of images and outputs the event information.
<Configuration 11>
The information processing apparatus according to the configuration 1 further includes an input unit configured to acquire sound information. The acquisition unit acquires position information about the subject and the event information based on the acquired sound information.
<Configuration 12>
In the information processing apparatus according to the configuration 1, the acquisition unit acquires the position of the virtual viewpoint and the line-of-sight direction from the virtual viewpoint. The determination unit controls the position of the virtual viewpoint and the line-of-sight direction from the virtual viewpoint acquired by the acquisition unit to be the position of the virtual viewpoint and the line-of-sight direction from the virtual viewpoint determined by the determination unit.
<Configuration 13>
The information processing apparatus according to the configuration 12 further includes an interpolation unit configured to generate interpolation information for controlling the acquired position of the virtual viewpoint and the acquired line-of-sight direction from the virtual viewpoint to be the determined position of the virtual viewpoint and the determined line-of-sight direction from the virtual viewpoint.
<Configuration 14>
In the information processing apparatus according to the configuration 13, the interpolation unit generates the interpolation information through spline interpolation.
<Configuration 15>
The information processing apparatus according to the configuration 12 further includes an input unit configured to enable a user to move the virtual viewpoint. The acquisition unit acquires the position of the virtual viewpoint and the line-of-sight direction from the virtual viewpoint based on information input by the user to the input unit.
<Configuration 16>
The information processing apparatus according to the configuration 1 further includes a first generation unit configured to generate the three-dimensional model of the subject based on the plurality of images, and a second generation unit configured to generate the virtual viewpoint image based on the three-dimensional model of the subject generated by the first generation unit, and the position of the virtual viewpoint and the line-of-sight direction from the virtual viewpoint determined by the determination unit.
<Method>
An information processing method for an information processing apparatus that determines a virtual viewpoint corresponding to a virtual viewpoint image that is generated using a three-dimensional model based on a plurality of images captured by a plurality of imaging apparatuses includes acquiring event information, and determining a position of the virtual viewpoint and a line-of-sight direction from the virtual viewpoint based on the event information before the three-dimensional model of a subject is generated.
<Storage Medium>
A non-transitory computer-readable storage medium stores a computer program for causing a computer to control each unit of the information processing apparatus according to the configuration 1.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment (s) and/or controlling the one or more circuits to perform the functions of one or more of the above-described embodiment (s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-096458, filed Jun. 15, 2022, which is hereby incorporated by reference herein in its entirety.

What is claimed is:

1. An information processing apparatus comprising:
one or more memories storing instructions; and
one or more processors executing the instructions to:
acquire event information; and
determine a position of a virtual viewpoint and a line-of-sight direction from the virtual viewpoint based on the event information before a three-dimensional model of a subject is generated.

2. The information processing apparatus according to claim 1,
wherein the event information is information indicating an action of the subject or an event caused by the subject.

3. The information processing apparatus according to claim 2,
wherein the event information is information including an event occurrence position indicating a position where the action of the subject is identified or a position where the event caused by the subject is identified, and
wherein the one or more processors further execute the instructions to determine the position of the virtual viewpoint and the line-of-sight direction from the virtual viewpoint so that the event occurrence position is included in a virtual viewpoint image.

4. The information processing apparatus according to claim 3, wherein the one or more processors further execute the instructions to determine the position of the virtual viewpoint and the line-of-sight direction from the virtual viewpoint so that the event occurrence position is at a center of the virtual viewpoint image.

5. The information processing apparatus according to claim 2, wherein the event information is information including an occurrence time of the action of the subject or the event caused by the subject.

6. The information processing apparatus according to claim 1, wherein the one or more processors further execute the instructions to:
acquire position information about the subject; and
determine, based on the position information about the subject, the position of the virtual viewpoint and the line-of-sight direction from the virtual viewpoint so that the subject is included in a virtual viewpoint image.

7. The information processing apparatus according to claim 6, wherein the one or more processors further execute the instructions to determine the position of the virtual viewpoint and the line-of-sight direction from the virtual viewpoint so that the subject is at a center of the virtual viewpoint image.

8. The information processing apparatus according to claim 6,
wherein a plurality of images is images of the subject captured from different directions, and
wherein the one or more processors further execute the instructions to acquire the position information about the subject by using a stereo matching method based on the plurality of images.

9. The information processing apparatus according to claim 1, wherein the one or more processors further execute the instructions to acquire the event information based on a plurality of images acquired by a plurality of imaging apparatuses installed to generate a virtual viewpoint image.

10. The information processing apparatus according to claim 9, wherein the one or more processors further execute the instructions to acquire the event information by using a learning model that inputs the plurality of images and outputs the event information.

11. The information processing apparatus according to claim 1, wherein the one or more processors further execute the instructions to:
acquire sound information; and
acquire position information about the subject and the event information based on the acquired sound information.

12. The information processing apparatus according to claim 1, wherein the one or more processors further execute the instructions to:
acquire the position of the virtual viewpoint and the line-of-sight direction from the virtual viewpoint; and
control the acquired position of the virtual viewpoint and the acquired line-of-sight direction from the virtual viewpoint to be the determined position of the virtual viewpoint and the determined line-of-sight direction from the virtual viewpoint.

13. The information processing apparatus according to claim 12, wherein the one or more processors further execute the instructions to generate interpolation information for controlling the acquired position of the virtual viewpoint and the acquired line-of-sight direction from the virtual viewpoint to be the determined position of the virtual viewpoint and the determined line-of-sight direction from the virtual viewpoint.

14. The information processing apparatus according to claim 13, wherein the interpolation information is generated by spline interpolation.

15. The information processing apparatus according to claim 12, wherein the one or more processors further execute the instructions to:
acquire input information for moving the virtual viewpoint by a user operation; and
acquire the position of the virtual viewpoint and the line-of-sight direction from the virtual viewpoint based on the input information.

16. The information processing apparatus according to claim 1, wherein the one or more processors further execute the instructions to:
generate the three-dimensional model of the subject based on a plurality of images acquired by a plurality of imaging apparatuses installed to generate a virtual viewpoint image; and
generate the virtual viewpoint image based on the generated three-dimensional model of the subject, the determined position of the virtual viewpoint, and the determined line-of-sight direction from the virtual viewpoint.

17. An information processing method comprising:
acquiring event information; and
determining a position of a virtual viewpoint and a line-of-sight direction from the virtual viewpoint based on the event information before a three-dimensional model of a subject is generated.

18. A non-transitory computer-readable storage medium storing a computer program for causing a computer to execute an information processing method comprising:
acquiring event information; and
determining a position of a virtual viewpoint and a line-of-sight direction from the virtual viewpoint based on the event information before a three-dimensional model of a subject is generated.
